(19) United States
(12) Patent Application Publication
(10) Pub. No.: US 2013/0073394 A1
(43) Pub. Date: Mar. 21, 2013

(54) HUMAN CURATED TARGETING OF OFFERS

(71) Applicants: Daniel Scalisi, Tarzana, CA (US); Douglas Plank, Malibu, CA (US); Nick Nayfack, Boulder, CO (US)

(72) Inventors: Daniel Scalisi, Tarzana, CA (US); Douglas Plank, Malibu, CA (US); Nick Nayfack, Boulder, CO (US)

(73) Assignee: MobileCause, Inc., Calabasas, CA (US)

(21) Appl. No.: 13/424,154

(22) Filed: Mar. 19, 2012

Related U.S. Application Data
(63) Continuation-in-part of application No. 12/948,091, filed on Nov. 17, 2010.
(60) Provisional application No. 61/362,291, filed on Jul. 7, 2010.
(60) Provisional application No. 61/350,389, filed on Jun. 1, 2010.

(51) Int. Cl. G06Q 30/02

(52) U.S. Cl. 705/14.64

(57) ABSTRACT

There is disclosed a method, apparatus and server for human curated targeting of offers. The method includes sending the link to the first offer to the first group of mobile devices via short message service using the first user group contact information; and accepting input of second user group contact information for a second group of mobile devices to which to provide the first offer from a mobile device of the first group of mobile devices. The method also includes retaining the first and second user group contact information and the first offer provided to the first and second groups of mobile devices. Finally, the method includes creating a second offer for at least one of the first and second groups of mobile devices based upon the input of the first and second user group contact information.

### RELATED APPLICATION INFORMATION

This patent is a continuation-in-part of U.S. patent application Ser. No. 12/948,091 filed on Nov. 17, 2010 and entitled “Systems and Methods for Fundraising via Mobile Applications”, which claims priority from Provisional Application No. 61/362,291 filed Jul. 7, 2010 entitled “Systems and Methods for Fundraising Via Mobile Applications” and claims priority from Provisional Application No. 61/350,389 filed Jun. 1, 2010 entitled “Systems and Methods for Fundraising Via Mobile Applications” which are incorporated herein by reference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to the human curated targeting of offers.

2. Description of the Related Art

Individuals have typically advertised, made requests for donations or made other types of offers to individuals primarily without any prior knowledge of those individual's preferences or interests. When such requests have been targeted based upon the others' individual preferences or interests, it has been based upon the targeting individual, organization or company's personal knowledge and awareness of those preferences and interests. Systems, such as social networks, have been devised whereby an individual's personal preferences are gathered and stored for later use in targeting offers to those users.

For example, an individual seeking donations for a particular charity organization, purchasers of a product or participation in a particular event is required to either send out an offer to an entire contact list or to specifically select individuals whom the individual believes will be most-likely to respond to the offer. Sending an offer to an entire contact list is unlikely to result in many acceptances of the offer without better targeting and potentially results in a great deal of unfruitful expense. Sending an offer to a select group inherently limits the request to those individuals selected and, further, requires the individual making the offer to obtain and input the limited set of contact information for those on the list.

Social networks, while useful in categorizing individuals, require that individual to affirmatively input information about their interests. Interest lists are not exhaustive and many users do not even bother to fill in interests. Further, the level of engagement of an individual with a particular cause, activity, or other interest identified on a social network is difficult to gauge without additional information regarding that user.

### DESCRIPTION OF THE DRAWINGS

FIG. 1 is a block diagram of a network of computing devices.

FIG. 2 is a block diagram of a computing device.

FIG. 3 is a block diagram of a system for human curated of targeting offers.

FIG. 4 is a screen display of an offer and the acceptance data obtained and stored as a result of acceptance of the offer.

FIG. 5 shows a flowchart of a method of human curated targeting offers.

FIG. 6 shows a flowchart of the generation of a new offer.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element in a figure having a figure number of the most significant digit of the reference designator.

### DETAILED DESCRIPTION

The present application is directed to the human curated targeting of offers. The targeting of subsequent offers is the result of stored individual referrals of a user for targeting of a prior offer. In view of the retention of this referral data, the user may be targeted for subsequent offers.

Unless explicitly stated otherwise, the term “offer” as used herein means a request for a donation to a cause, an advertisement for a product or service or an invitation to participate in an activity. An “offer link” is a hypertext, extensible markup language or other data that directs a recipient to an offer.

Unless explicitly stated otherwise, the term “user” as used herein refers to an individual operating a computing device, such as a mobile device, to generate, receive, accept, or forward an offer.

Unless explicitly stated otherwise, the terms “accept” or “acceptance” in reference to an offer as used herein refers to a user's interaction with a mobile device to thereby indicate a desire to make a donation to a cause, to purchase a product or service, or to participate in an activity identified by an offer.

Unless explicitly stated otherwise, the term “forward” in reference to an offer as used herein refers to a user's interaction with a mobile device to thereby send a received offer to additional users. The forward may include user modifications to the offer before it is sent to additional users.

Description of Apparatus

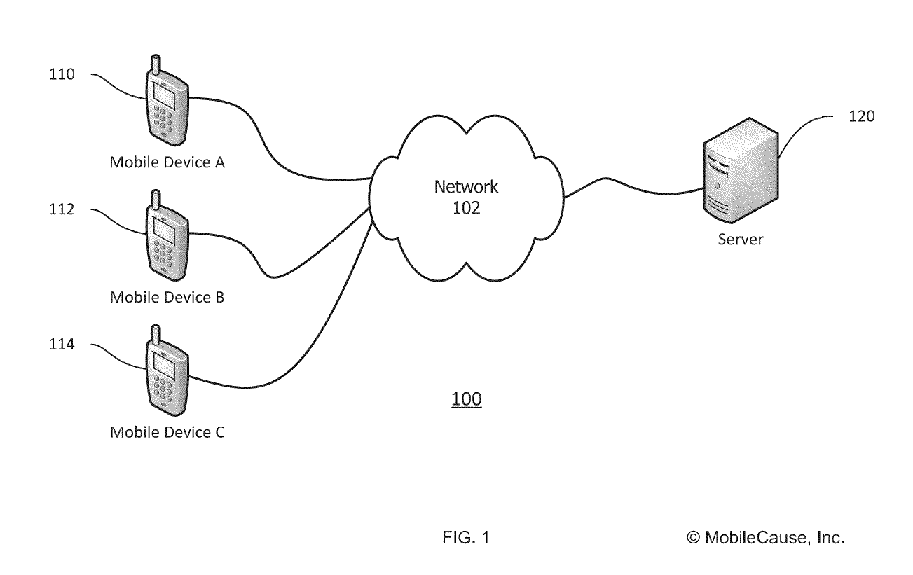

Referring now to FIG. 1, a block diagram of a network of computing devices is shown. The system 100 includes mobile devices A 110, B 112, and C 114 along with server system 120, all interconnected by a network 102. The system 100 may be implemented in a distributed computing environment and interconnected by the network 102.

The network 102 may be or include a local area network, a wide area network, a personal area network, the Internet, an intranet, or any combination of these. The network 102 also includes wireless access suitable for connecting each of the mobile devices A 110, B 112, and C 114 such as a mobile phone network, radio network or other wide area network suitable for use with wireless mobile devices. The network 102 may have physical layers and transport layers according to IEEE 802.11, Ethernet or other wireless or wire-based communication standards and protocols such as WIMAX®, BLUETOOTH®, the public switched telephone network, a proprietary communications network, infrared, and optical.

Each of the mobile devices A 110, B 112 and C 114 are portable devices, such as portable telephones, hand-held computers, tablet computers, laptops or other similar devices capable of connection to and network communication with the server 120 via the network 102. The mobile devices A 110, B 112 and C 114 are capable of receiving short message service (SMS) messages, emails, accessing web pages and various other functions, including accessing the server system 120, via the network 102. Three mobile devices A 110, B 112 and C 114 are shown, but any number of mobile devices may access and be accessed by the network 102.

The server system 120 is a server computer connected to the network 102. The server system 120 may act as a web server, a database server, or both and may be made up of one or more physical servers in a single location or a distributed group of servers. As will be discussed in more detail below, the server system 120 provides an interface for generating and customizing offers made to groups of individuals. The server system 120 also acts to store data pertaining to users of mobile devices A 110, B 112 and C 114 as the users of those devices interact with the server system 120.

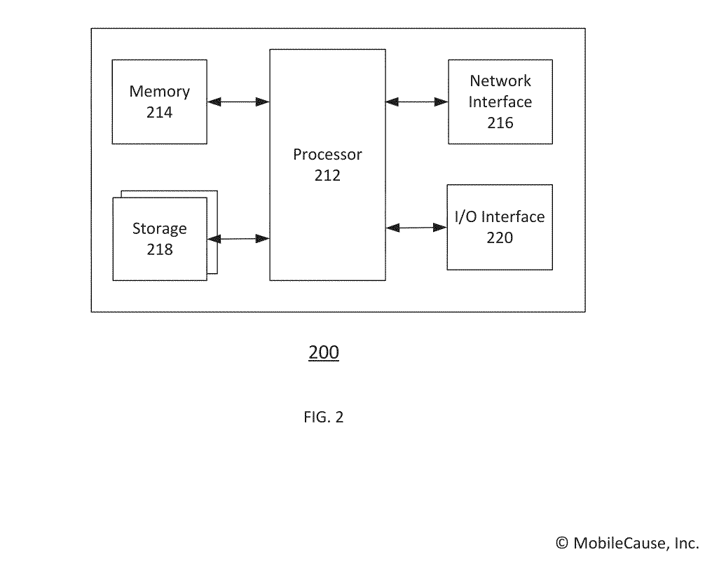

Turning now to FIG. 2 there is shown a block diagram of a computing device 200, which is representative of the server system, mobile devices and other computing devices discussed herein. The computing device 200 may include software and/or hardware for providing functionality and features described herein. The computing device 200 may therefore include one or more of: logic arrays, memories, analog circuits, digital circuits, software, firmware and processors. The hardware and firmware components of the computing device 200 may include various specialized units, circuits, software and interfaces for providing the functionality and features described herein.

The computing device 200 has a processor 212 coupled to a memory 214, storage 218, a network interface 216 and an I/O interface 220. The processor 212 may be or include one or more microprocessors, field programmable gate arrays (FPGAs), application specific integrated circuits (ASICs), programmable logic devices (PLDs) and programmable logic arrays (PLAs).

The memory 214 may be or include RAM, ROM, DRAM, SRAM and MRAM, and may include firmware, such as static data or fixed instructions, BIOS, system functions, configuration data, and other routines used during the operation of the computing device 200 and processor 212. The memory 214 also provides a storage area for data and instructions associated with applications and data handled by the processor 212.

The storage 218 provides non-volatile, bulk or long term storage of data or instructions in the computing device 200. The storage 218 may take the form of a magnetic or solid state disk, tape, CD, DVD, or other reasonably high capacity addressable or serial storage medium. Multiple storage devices may be provided or available to the computing device 200. Some of these storage devices may be external to the computing device 200, such as network storage or cloud-based storage. As used herein, the term storage medium corresponds to the storage 218 and does not include transitory media such as signals or waveforms. In some cases, such as those involving solid state memory devices, the memory 214 and storage 218 may be a single device.

The network interface 216 includes an interface to a network such as network 102 (FIG. 1).

The I/O interface 220 interfaces the processor 212 to peripherals (not shown) such as displays, keyboards and USB devices.

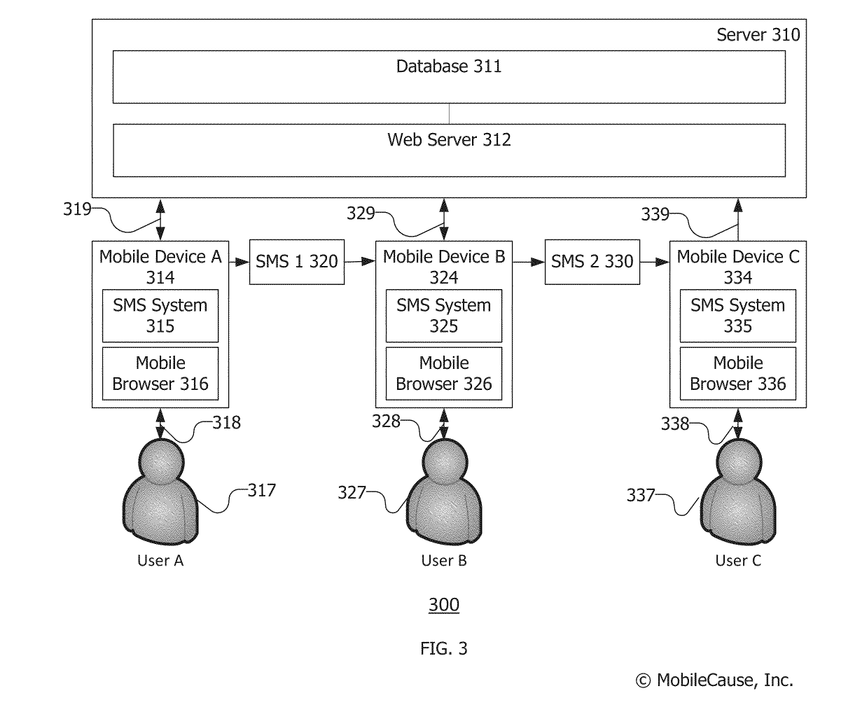

FIG. 3 shows a block diagram of a system for human curated targeting of offers. The system 300 includes a server 310 including a database 311 and a web server 312. The server 310 is in communication with mobile devices A 314, B 324 and C 334. Mobile devices A 314, B 324 and C 334 include SMS systems 315, 325 and 335 and mobile browsers 316, 326 and 336, respectively. Mobile device A 314 is used by user A 317, mobile device B 324 is used by user B 327 and mobile device C 334 is used by user C 337. Users A 317, B 327 and C 337 interact with mobile devices A 314, B 324 and C 334 via device to user interfaces 318, 328 and 338, respectively. Mobile devices A 314, B 324 and C 334 interact with the server via a network communications 319, 329 and 339, respectively.

SMS 1 320 is used to communicate between mobile device A 314 and mobile device B 324. SMS 2 330 is used to communicate between mobile device B 324 and mobile device C 334. Although SMS 1 320 and SMS 2 330 are shown as direct communications between their respective mobile devices, a mobile telephone network is employed to transmit SMS 1 320 and SMS 2 330 between those mobile devices.

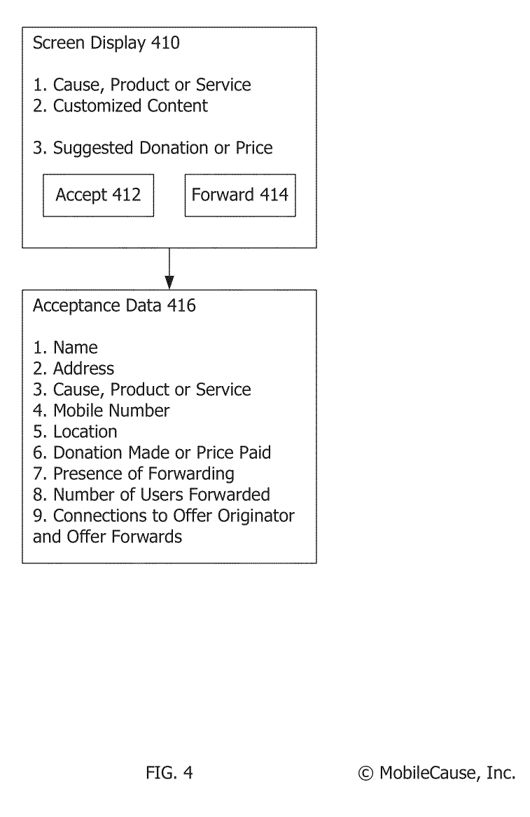

The server 310 is software operating on a server system, such as server system 120 (FIG. 1). The server 310 includes, at least, a database 311 and a web server 312. As users A 317, B 327 and C 338 interact with the web server 312, data input pertaining to the offer is stored by database 311. This data will be discussed more fully with reference to FIG. 4 below.

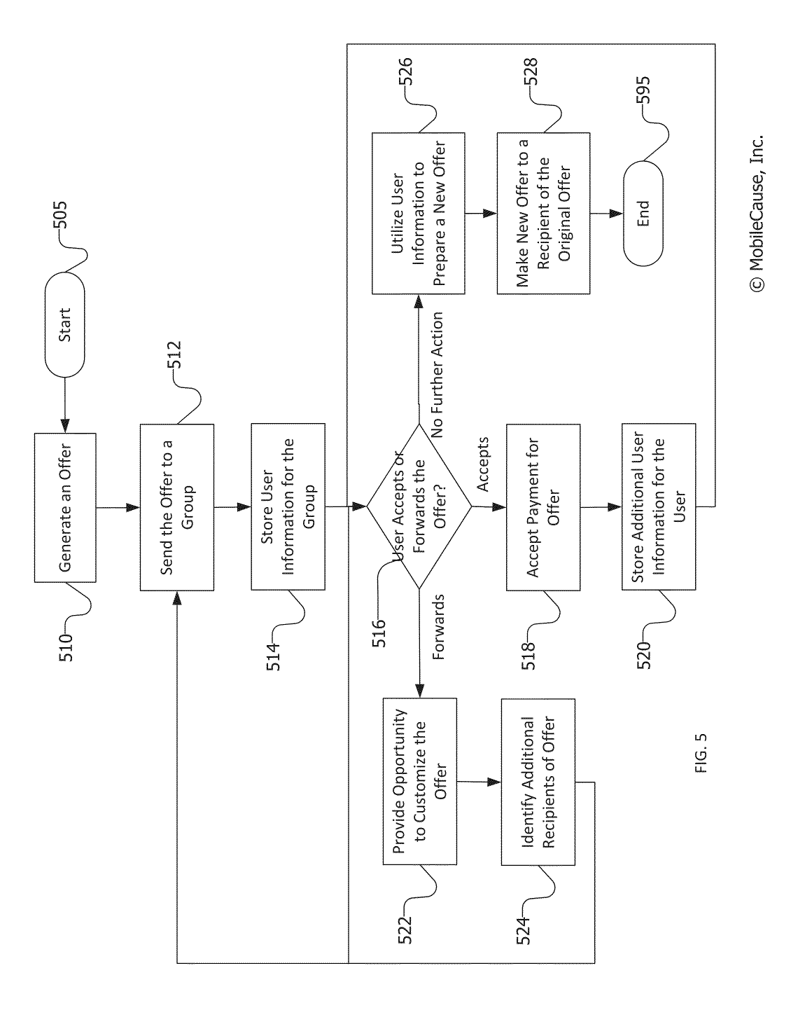

As will be described in more detail below with respect to FIG. 5, an initiating user, such as user A 317 utilizes a web-based or stand-alone application to create an offer. This offer may be created by user a 317 interaction with a mobile device, such as mobile device A 314 or a personal computer. The offer may be created using an interactive web page viewable on a mobile browser 316 or personal computer web browser. Alternatively, the offer may be created using an application on the mobile device or personal computer. The offer is created at the direction of the initiating user. Individuals identified by the initiating user may receive, accept or forward the offer.

For example, user A 317 may use the mobile browser 316 of mobile device A 314 in communication with server 310 using the network communications 319 to create an offer. User A 317 may interact with the mobile device A 314 using the device to user interface 318 to create the offer.

The server 310 may then send an offer link (such as a hyperlink) to mobile device A 314 using the network communications 316. When clicked, the offer link directs a recipient to the server 310 to view the offer. User A 317 may then forward the offer link from mobile device A 314 to mobile device B using SMS system 315 via SMS 1 320. Mobile device B 329 is shown as a single device, but the offer link may be forwarded via SMS 1 320 to entire groups of users (via their mobile devices) identified by user a 317 at once.

User B 327 is provided an opportunity to accept the offer and to revise and forward an offer link to further users. Specifically, user B 327 is presented with the offer link received via SMS system 325 and may interact with the offer link to view the offer in mobile browser 326, both operating on mobile device B 324. The offer link will direct the mobile browser 326 to web server 312 via network communications 329. User B 327 may interact with mobile device B 324 via the device to user interface 328 to indicate acceptance of the offer to the web server 312. User B may similarly interact with the device to user interface 328 to create a revised offer using mobile browser 326 and receive a revised offer link, via the network communications 329 to the mobile browser 326, to the revised offer. This revised offer may be forwarded via SMS 2 330 using SMS system 325 to mobile device C 334.

Mobile device C 334 may receive the revised link via SMS 2 330 into SMS system 335. SMS system 335 presents the revised offer link to user C 337. User C 337 may indicate, via the device to user interface 338 that he or she wishes to load the revised offer via mobile browser 336. The mobile browser 336 loads the offer based upon interaction between the web server 312 and mobile browser 336 via the network communications 339 and in response to user C 337 interaction with the revised offer link. User C 337 may then indicate acceptance of the revised offer using the device to user interface 338 to interact with the mobile browser 336 via network communications 339. User C 337 may elect not to revise and forward the offer. In this way, the system may simultaneously enable a chain of users to provide offer links, each to the same offer, which may or may not be customized, to a series of users via a series of SMS messages between those users.

Turning now to FIG. 4, a screen display 410 of an offer and the acceptance data 416 obtained and stored as a result of acceptance of the offer is shown. The screen display 410 is an abstract example of a screen display of an offer for a cause, product or service. The offer shown in the screen display 410 includes details regarding the offer such as the cause, product or service, any user-customized content and a suggested donation for the cause or price for the product or service. The suggested donation or price may be pre-set by the user forwarding the offer, by the cause or by the seller. Alternatively, a floor or ceiling may be set by the user forwarding the offer, by the cause or by the seller. The customized content may be an aspect of the offer that may be edited, in turn, by each of the recipients of the offer before it is forwarded to a new group of recipients. The screen display 410 of the offer also includes an accept function 412 and a forward function 414. Accept function 412 and forward function 414 may be buttons, hyperlinks or similar elements suitable for user interaction.

If the offer shown in the screen display 410 is accepted, acceptance data 416 shows the results of that acceptance. Various acceptance data 416 pertaining to the acceptance is obtained. Some examples of the potential acceptance data 416 are shown. The name, address, cause, mobile number that received the offer, the location of the mobile device when it responded to the offer, the donation made or price paid, the presence of forwarding of the offer by that user, the number of users to whom the offer was forwarded by that user and the connections between the initiating user and users receiving the offer may be obtained and stored during the acceptance 416.

The accept function 412 leads to the acceptance 416 which directs the user accepting the offer to a web interface wherein the information required to make the donation or complete the sale may be obtained. This data may be the data shown in the acceptance data 416, but may include additional data elements. Alternatively, an application, such as a mobile application, may be launched on the user's mobile device in order to complete the acceptance of the offer 410. The acceptance data 416 is then stored in a database, such as database 311 (FIG. 3).

Similarly, the forward function 414 takes the user to a web interface whereby the display screen used for the offer may be customized by the recipient prior to forwarding to further recipients. Alternatively, a mobile application may be launched on the user's mobile device to enable customization of the offer. As a part of this process, the user may be provided a link designed to direct subsequent users to a display screen for a customized offer. This link may be used to forward the customized offer, via SMS message to further recipients. The user may be provided with an interface for selecting from a contact list resident on the user's mobile device to which to send the link to the customized offer. Alternatively, email, social networking, micro-blogging, blogging, instant messaging or other messaging services may be used to direct further recipients to the customized offer. Access to these types of offer forwarding outlets may be enabled by application programming interfaces (APIs) associated with those services which may be integrated into aspects of the web interface or application.

Description of Processes

Referring now to FIG. 5, a flowchart of a method of human curated targeting offers is shown. After the process starts 505, the user interacts with a server to generate an offer 510. The user may, for example, interact with a web application that enables the user to create an offer. This web application may be optimized for mobile devices.

Alternatively, a stand-alone mobile application may be used to create an offer or an offer creation interface may be integrated into a larger, overall web or mobile application. For example, a mobile application associated with a particular retailer or cause may incorporate numerous aspects, such as news, announcements, donation or product browsing in addition to an offer generation functionality associated with element 510 into a single mobile application. In this way, this aspect may be integrated into a larger, overall web or mobile application.

Next, the user may cause the offer to be sent to mobile devices associated with a selected group of users at 512. This process may involve a hyperlink provided as a result of the generation of the offer at 510 that may, in turn, be forwarded to the first group. This offer may be sent at 512 using short message service (SMS), email, social networking, micro-blogging, blogging, instant messaging, a mobile application or other messaging services.

As the offer is sent to the first group 512, either directly by the user via SMS or other messaging service or by a server, the user information related to the initiating user is stored at 514, that information including the user's name, mobile telephone number, location (if available), email address and the cause, product or service to which the offer is directed. In addition, the name, mobile telephone number, location may be stored for each of the group of recipients of the offer 514. If the offer is provided by some method other than SMS, then the contact information associated with that contact method may be stored instead of or in addition to the user's mobile telephone number. The individuals selected for inclusion in the group may be categorized based upon their identification as a recipient of this offer.

The users that receive the offer are presented with an opportunity to accept or forward the first offer 516. If a user accepts the offer at 516, then the server accepts payment for the first offer 518. At this point, the user is directed to a mobile browser, mobile application or other, similar system whereby the user is able to make a payment for the donation, product or service. During the payment process, the user provides additional information such as a billing address, a name, an email address, and a GPS or other location may be provided by a user's mobile device. The presence of forwarding and connections between the initiating user and forwarded may also be stored. Additional information may be provided by the user as a part of this process, including the opportunity to sign up for further communications regarding the donation, product, service or the individual or group who initially provided the offer. This information is stored 520. As a part of this storing process, the individuals selected for inclusion in the group may be categorized based upon their identification as a recipient of this offer.

Next, or if a user elects to forward the offer, then the process provides the opportunity of that user to customize the first offer 522. Though this variation is presented, the user may alternatively decide to forward the offer prior to accepting the offer themselves. However, the most typical process flow would be acceptance followed by forwarding of the first offer.

Once the user has customized the first offer 522, that user may identify additional recipients of the customized offer 524. This process may involve selection by the user of a series of mobile telephone numbers, email addresses, instant messaging usernames, social networking profiles or other unique identification associated with the selected recipients. The user may then provide the offer to the mobile devices associated with the identified individuals in the group 512. The process begins anew based upon the customized offer. Simultaneously, the user forwarding the customized offer is again presented with the opportunity to accept or forward the offer at 514. This process may take place for every user originally identified in the group 512 and all subsequent recipients of the same offer.

If no further action by a user is taken, then the stored information may be utilized to prepare a new offer at 526. In particular, the names, addresses, cause, product or service, mobile number, location, donation or price paid, presence of forwarding of a prior offer (and the associated cause, product or service) in addition to the connections between the initiating user and individuals to whom the initial offer was forwarded may be accessed in order to prepare the new offer.

Once a user is identified using the server, a second offer is made to at least one of the recipients of the initial offer 528 based upon the user's identification as a recipient of the initial offer. In particular, the mobile device, email address, physical address, instant messaging username, social networking profile, mobile application profile or other messaging method may be the target of the new offer such that the offer is made to the user based upon their selection by another user as a recipient of the initial offer.

FIG. 5 has both a start 505 and an end 595, but the process may be cyclical in nature with multiple instances, for example, multiple levels of offerees and offerors of the same offer in addition to multiple offers for different causes, products or services all taking place simultaneously. In addition, portions of the process may take place at the same time.

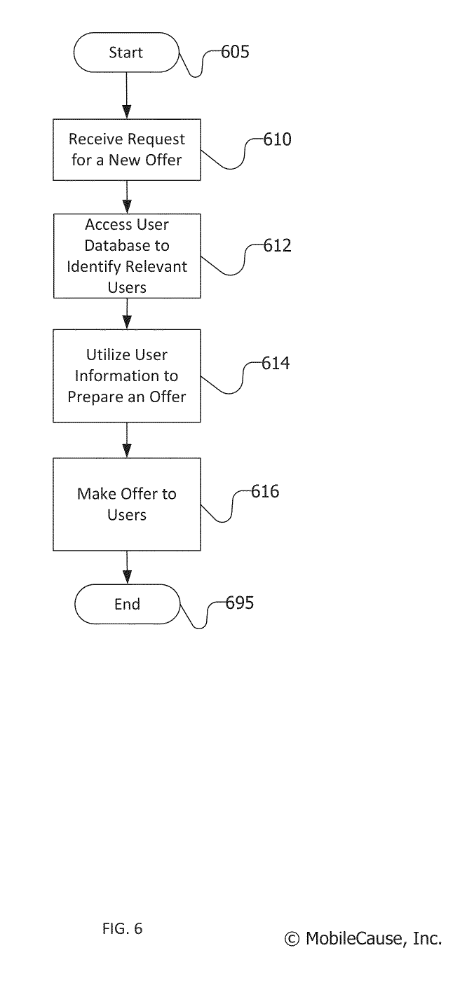

Turning now to FIG. 6, a flowchart of the generation of a new offer is shown. First, the server (such as server 310 in FIG. 3) receives a request for a new offer 610, such as the new offer prepared in 526 (FIG. 5). This request may take the form of a direct offeror query to a database (such as database 311 of FIG. 3) on the server or a search for prior offer recipients meeting certain criteria. The request may take the form of a request received via an integrated application programming interface used by a web-based or other application. This request will seek users meeting particular characteristics based upon prior offers made to those users and the users' reaction to those offers. The user's identification by another individual as a recipient of an offer may be taken into account when seeking users for the new offer.

Access to the server's database may be controlled using a login and password, a certificate, a signature process for signing requests to confirm their authenticity, a unique API key and IP address combination and/or similar authentication methodologies. Once authenticated, the user may access the database to identify relevant users 612. This access involves processing the request received at 610 in order to provide output to the requester.

After the server has provided that information, a second offer is prepared 614 for one or more individuals identified in the database based upon their inclusion in a prior offer. This decision may be based upon their being added to a list of individuals to whom the offer was provided, upon their response to the offer (either accepting or rejecting it) or based upon their forwarding (or not forwarding) the offer to others who may or may not have participated. The level of involvement in the first offer may be gauged by the requestor in preparing the second offer. The second offer may be provided directly by the server or may be provided by the requestor. Finally, the offer is made to the user or users 616 identified 612.

By way of an example, if a user receives a forward of an offer to make a donation to a particular cause, then the user accepts that offer and forwards the offer to a group of friends using this system, then the server now has human-generated information that may be relevant for future offers. Namely, the server has information indicating that that user has been identified by another human as potentially interested in the cause. Second, the user has self-identified as interested in the cause based upon his or her acceptance of the offer. Third, the user has still more self-identified interest in the cause through his or her decision to forward the offer to the group of friends. If some or all of those friends accept the invitation, it is still more likely that the user's interest in that cause is strong.

As a result of all of this human-input information, a subsequent cause or the same cause may wish to generate a new offer. Using software suitable for accessing the server's databases, the cause, someone affiliated with the cause or a similar cause may search for and select this same user for receipt of a subsequent offer. Because of the user's self-identification and identification by friends and of friends who previously made a donation to the cause, the cause or a similar cause would be wise to provide future offers to that individual.

Through the user's prior acceptance of the offer, the server has contact information such as a mobile telephone number and location information for that user. A local subsidiary of a large national cause may seek to contact that individual directly, either with an offer using this system or by a direct mailing, email or other offer of involvement or further donation to the cause. Given the information regarding the user's prior interactions with the offer, it is likely that the user would be more receptive to such an offer.

Similarly, if an offer for a product or service is made to a user who subsequently accepts the offer, a retailer in the same area as the user accepting the offer may wish to make a subsequent offer of an accessory to go along with the product. The user's receipt of the original offer for the product, as identified by another individual, in conjunction with the user's acceptance of the offer and purchase of the product demonstrates that the user would likely be interested in a subsequent offer related to that product. Accordingly, future offers may target this individual based upon the user's interaction with the original offer.

FIG. 6 has both a start 605 and an end 695, but the process may be cyclical in nature with multiple instances, for example, multiple database queries taking place simultaneously. In addition, portions of the process may take place at the same time.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A method for human curated targeting of offers comprising:
generating a first offer at a user's direction;
accepting input of first user group contact information for a first group of mobile devices to which to provide a link to the first offer;
sending the link to the first offer to the first group of mobile devices via short message service using the first user group contact information;
accepting input of second user group contact information for a second group of mobile devices to which to provide the first offer from a mobile device of the first group of mobile devices;
sending the link to the first offer to the second group of mobile devices via short message service using the second user group contact information;
retaining the first and second user group contact information and the first offer provided to the first and second groups of mobile devices; and
creating a second offer for at least one of the first and second groups of mobile devices based upon the input of the first and second user group contact information.

2. The method of claim 1 wherein the first and second user group contact information include mobile telephone numbers associated with each of the first and second groups of mobile devices.

3. The method of claim 1 wherein the first and second user group contact information include the names of each individual associated with each of the first and second groups of mobile devices.

4. The method of claim 1 wherein the link to the first offer directs a user to a web page that enables the user to make a payment and to forward the link the first offer with further customization.

5. The method of claim 1 wherein the first and second user group contact information and the first offer are stored in a database that categorizes individuals based upon their selection by a human for receipt of the link to the first offer.

6. The method of claim 1 further comprising retaining the locations of the first and second groups of mobile devices along with the first and second user group contact information.

7. Apparatus comprising a storage medium storing a program for human curated targeting of offers, the program having instructions which when executed by a processor will cause the processor to:
generate a first offer at a user's direction;
accept input of first user group contact information for a first group of mobile devices to which to provide a link to the first offer;
send the link to the first offer to the first group of mobile devices via short message service using the first user group contact information;
accept input of second user group contact information for a second group of mobile devices to which to provide the link to the first offer from a mobile device of the first group of mobile devices;
send the link to the first offer to the second group of mobile devices via short message service using the second user group contact information;
retain the first and second user group contact information and the first offer provided to the first and second groups of mobile devices; and
create a second offer for at least one of the first and second groups of mobile devices based upon the input of the first and second user group contact information.

8. The apparatus of claim 7 wherein the first and second user group contact information include mobile telephone numbers associated with each of the first and second groups of mobile devices.

9. The apparatus of claim 7 wherein the first and second user group contact information include the names of each individual associated with each of the first and second groups of mobile devices.

10. The apparatus of claim 7 wherein the link to the first offer directs a user to a web page that enables the user to make a payment and to forward the link the first offer with further customization.

11. The apparatus of claim 7 wherein the first and second user group contact information and the first offer are stored in a database that categorizes individuals based upon their selection by a human for receipt of the link to the first offer.

12. The apparatus of claim 7 wherein the processor will further cause the processor to retain the locations of the first and second groups of mobile devices along with the first and second user group contact information.

13. A server for human curated targeting of offers comprising:
a network interface for
communicating with a user to generate a first offer at the user's direction,
accepting input of first user group contact information for a first group of mobile devices to which to provide a link to the first offer,
sending the link to the first offer to the first group of mobile devices via short message service using the first user group contact information,
accepting input of second user group contact information for a second group of mobile devices user group to which to provide the first offer from a mobile device of the first group of mobile devices,
sending the first offer to the second group of mobile devices via short message service using the second user group contact information,
data storage for retaining the first and second user group contact information and the first offer provided to the first and second groups of mobile devices; and
a processor for accessing the data storage to create a second offer for at least one of the first and second groups of mobile devices based upon the input of the first and second user group contact information.

14. The server of claim 13 wherein the first and second user group contact information include mobile telephone numbers associated with each of the first and second groups of mobile devices.

15. The server of claim 13 wherein the first and second user group contact information include the names of each individual associated with each of the first and second groups of mobile devices.

16. The server of claim 13 wherein the link to the first offer directs a user to a web page that enables the user to make a payment and to forward the link the first offer with further customization.

17. The server of claim 13 wherein the first and second user group contact information and the first offer are stored in a database that categorizes individuals based upon their selection by a human for receipt of the link to the first offer.

18. The server of claim 13 wherein the data storage is further for retaining the locations of the first and second groups of mobile devices along with the first and second user group contact information.
